(19) United States
(12) Patent Application Publication
(10) Pub. No.: US 2026/0101378 A1
(43) Pub. Date: Apr. 9, 2026

(54) PHYSICAL RANDOM ACCESS CHANNEL AVAILABILITY INDICATION

(71) Applicant: QUALCOMM Incorporated, San Diego, CA (US)

(72) Inventors: Ahmed Attia ABOTABL, San Diego, CA (US); Hung Dinh LY, San Diego, CA (US)

(21) Appl. No.: 18/910,892

(22) Filed: Oct. 9, 2024

(51) Int. Cl. H04W 74/0833; H04W 68/02

(52) U.S. Cl. CPC H04W 74/0833; H04W 68/02

(57) ABSTRACT

Certain aspects of the present disclosure provide techniques for wireless communications by an apparatus, such as a user equipment (UE). The method includes receiving, from a network entity, a message comprising physical random access channel (PRACH) adaptation information, wherein the PRACH adaptation information is included in one of: one or more reserved bits of the message, or a paging early indication (PEI) of the message; and performing a random access channel (RACH) procedure based on the PRACH adaptation information.

### INTRODUCTION

### Field of the Invention

Aspects of the present disclosure relate to wireless communications, and more particularly, to techniques for random access communications.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications by an apparatus. The method includes receiving, from a network entity, a message comprising physical random access channel (PRACH) adaptation information, wherein the PRACH adaptation information is included in one of: one or more reserved bits of the message, or a paging early indication (PEI) of the message; and performing a random access channel (RACH) procedure based on the PRACH adaptation information.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5A depicts an example four-step random access procedure.

FIG. 5B depicts an example two-step random access procedure.

FIG. 6 depicts example mappings of synchronization signal blocks (SSBs) to random access occasions (ROs) in time-frequency domains for sets of random access parameters.

FIG. 7 depicts an example process flow for communications in a network between a network entity and a UE to adapt a RACH configuration.

FIG. 8 depicts an example of signaling for a paging cycle.

FIG. 9 depicts a process flow for communications in a network between a network entity and a UE to communicate physical random access channel (PRACH) availability indication.

FIG. 10 depicts another process flow for communications in a network between a network entity and a UE to communicate PRACH availability indication.

FIG. 11 depicts a method for wireless communications.

FIG. 12 depicts aspects of an example communications device.

### DETAILED DESCRIPTION

Aspects of the present disclosure provide apparatuses, methods, processing systems, and computer-readable mediums for indication of physical random access channel (PRACH) availability.

A user equipment (UE) of a wireless communications network may perform a random access channel (RACH) procedure for various purposes, such as initial access, random-access-based handover, or connection reestablishment. A RACH procedure involves the transmission of a RACH preamble on a time-frequency resource configured for a device to perform a RACH procedure, referred to herein as a RACH occasion (RO). A UE may be configured with a number of ROs, and different ROs may be associated with different parameters, such as different synchronization signal blocks. A RACH procedure may be performed using a PRACH. In some contexts, “RACH” and “PRACH” may be used interchangeably.

It may be beneficial to support adaptation of the ROs configured for a UE. For example, in some contexts, it may be beneficial for one type of UE to have a baseline set of ROs, and for another type of UE (such as a UE supporting network energy savings (NES) technology) to have additional ROs in addition to the baseline set of ROs. The additional ROs may be configured, for example, via semi-static signaling, and may subsequently be activated or deactivated. For example, a network entity may provide PRACH adaptation information that includes an indication of an activation state for PRACH adaptation, where the indication of the activation state for the PRACH adaptation indicates activation or deactivation of one or more PRACH adaptations. In some aspects, when the indication of the activation state for the PRACH adaptation indicates activation, a UE may apply and/or activate the one or more PRACH adaptations indicated in the PRACH adaptation information for performing a RACH procedure.

In the example described above, the one or more PRACH adaptations may include activating the additional ROs for use by the UE. For example, a PRACH adaptation may be used to optimize a number of ROs. The PRACH adaptation may include adjusting a number of ROs configured for the device via a PRACH configuration, where the adjustment may include increase or decrease of the number of configured ROs. For example, the UE may obtain an updated PRACH configuration, such as via system information, that increases or decreases the number of configured ROs. Additionally, or alternatively, the PRACH adaptation may include activating a set of ROs that are already configured for the device via a PRACH configuration.

In some aspects, a relatively small number of ROs may be configured for a device, and PRACH adaptation may dynamically add more ROs to a PRACH configuration based on an identified need by a network entity. For example, the identified need to increase the number of ROs may be caused by a greater number of devices entering a coverage area of the network entity, and the greater number of devices may then attempt to perform respective RACH procedures to connect to the network entity. Thus, the increased number of ROs may reduce a chance that the respective RACH procedures interfere with one another and/or may provide more opportunities for the greater number of devices to perform the respective RACH procedures, thereby increasing a likelihood that the respective RACH procedures are successful. Additionally, or alternatively, the identified need to increase the number of ROs may be caused by the network entity identifying an increase in downlink traffic to be sent to devices located in a coverage area of the network entity and/or an increase in expected uplink traffic from the devices.

In some aspects, a relatively large number of configured ROs may be configured for a device, and PRACH adaptation may dynamically reduce and/or remove/mute ROs based on an identified need by a network entity. For example, the identified need to reduce and/or remove/mute a number of ROs may be caused by a decrease in a number of devices being in a coverage area of the network entity, such that a dense configuration of ROs is excessive or no longer needed for the decreased number of devices. Additionally, or alternatively, the identified need to reduce and/or remove/mute a number of ROs may be caused by the network entity identifying a decrease in downlink traffic to be sent to devices located in a coverage area of the network entity and/or a decrease in expected uplink traffic from the devices.

In some aspects, the above described examples of adjusting a number of configured ROs may include adapting PRACH configurations in a time domain. For example, adapting the PRACH configuration may include increasing or reducing a periodicity of ROs, which may result in the number of configured ROs being adjusted for a given time duration. That is, a higher periodicity may correspond to a higher number of configured ROs for the given time duration, and a lower periodicity may correspond to a lower number of configured ROs for the given time duration.

Additionally, or alternatively, adapting PRACH configurations may be performed in a spatial domain. In some aspects, the network entity may send synchronization signals to devices in a coverage area of the network entity, where the synchronization signals are sent via respective beams. The synchronization signals and corresponding beams may be associated with one or more respective ROs, such that the device may determine which ROs to use for performing a RACH procedure based on which synchronizations signals are received and/or on which beams the synchronization signals are received. For example, a first set of synchronization signals may be sent via a first beam from the network entity, and the first set of synchronization signals and/or first beam may correspond to one or more first ROs, such that a device receiving the first set of synchronization signals via the first beam may determine to use the one or more first ROs to perform a RACH procedure to connect to the network entity.

One or more technical problems arise when one or more PRACH adaptations of a PRACH configuration are applicable for certain UEs but not for other UEs. For example, these PRACH adaptations may be additional PRACH adaptations that are dynamically configured or activated and are applicable for UEs that support a certain technology (such as NES) but not for UEs that do not support the certain technology. In some aspects, the UEs for which the additional PRACH adaptations are applicable may be configured for certain capabilities. For example, such UEs for which the additional PRACH adaptations are applicable may be NES-capable UEs. That is, in certain aspects, the additional PRACH adaptations may only be applicable for certain UEs, such as UEs that support a later generation-based release of a radio access technology or NES-capable UEs, but not for legacy UEs.

In some aspects, an indication of additional PRACH adaptations may be communicated to UEs via semi-static signaling. For example, such semi-static signaling may be performed via a system information message, such as a system information block (SIB), including a first system information block (SIB1) or another SIB. For each indication of the additional PRACH adaptations in the system information message, there is a paging message sent to the UEs to inform the UEs of a corresponding system information update. However, the indication of the additional PRACH adaptations, such as an indication of availability of additional PRACH resources, in the system information message may cause the UEs to expend power for receiving and decoding the system information message, even when these additional PRACH adaptations may not be applicable for certain UEs, such as legacy UEs. Accordingly, an improvement for indication of additional PRACH availability is desired.

Aspects of the present disclosure provide a technical solution for how additional PRACH availability may be indicated, where the additional PRACH availability may be applicable for or readable by certain UEs, such as NES-capable UEs, but not for other UEs, such as legacy UEs. For example, a paging message such as a paging downlink control information (DCI) message may include one or more reserved bits to indicate update of SIB1 for the adaptation of the additional PRACH resources, such that any impact on the legacy UEs is avoided when a system information message such as SIB1 indicates adaptation of additional PRACH resources. For example, the one or more reserved bits may be readable by UEs for which the additional PRACH resources may be applicable (e.g., NES-capable UEs, UEs supporting a later generation-based release of a radio access technology, etc.), but not readable by legacy UEs for which the additional PRACH resources may not be applicable. That is, the one or more reserved bits may be different from one or more defined fields of the paging DCI message that are readable by the legacy UEs. The paging DCI message (including one or more reserved bits configured with an indication of the additional PRACH availability) may cause the UEs that support the later generation-based release of a radio access technology or the NES-capable UEs to receive and decode a SIB1 for adaptation of the additional PRACH resources applicable only for the UEs that support the later generation-based release of a radio access technology or the NES-capable UEs, while enabling the legacy UEs to avoid unnecessarily receiving and decoding such SIB1. A UE may then perform a RACH procedure based on available PRACH resources.

In certain aspects, a UE may be monitoring for a paging early indication (PEI), and the PEI may include information related to additional PRACH adaptations. For example, the PEI may include a first indication that there is no paging to monitor during a given paging frame and a second indication that there is an update in system information related to the additional PRACH adaptations. The first indication may be readable by both UEs that support a later generation-based release of a radio access technology and legacy UEs, and the second indication may be readable by only the UEs that support the later generation-based release of a radio access technology. In this example, the UE monitoring the PEI can avoid unnecessarily receiving and decoding a paging indication associated with any system information update related to the additional PRACH adaptations. At the same time, such UE can receive and decode a system information message that carries information relating to the additional PRACH adaptations based on the second indication that there is an update in the system information.

In another example, the PEI itself may include first data corresponding to the additional PRACH adaptations, which is not readable by the legacy UEs, as well as second data indicating that there is no paging to monitor during a given paging frame, which is readable by the legacy UEs. In this example, the UE monitoring the PEI can avoid necessarily receiving and decoding a paging indication associated with any system information update related to the additional PRACH adaptations, as well as receiving any system information message such as a SIB1 itself. That is, the PEI itself may include all information that the UE needs to adapt additional PRACH resources corresponding to the indication of the additional PRACH adaptations included in the PEI, such that the UE can adapt the additional PRACH resources based on the PEI without receiving and decoding any system information message.

The techniques for indicating additional PRACH availability as described herein may provide any of various beneficial technical effects and/or advantages. For example, UEs, such as legacy UEs, for which the additional PRACH availability is not applicable may save energy by avoiding unnecessarily monitoring and/or decoding a SIB1 when the SIB1 includes update information regarding the additional PRACH availability that is not applicable for the legacy UEs. Additionally, if such legacy UEs are monitoring PEI, the UEs may further save energy by avoiding unnecessarily monitoring and/or decoding a paging indication, such as a paging DCI message to be received over a paging occasion (PO), where “PO” refers to a time interval when paging is periodically scheduled for being communicated. Accordingly, aspects of the present disclosure enable such UEs to save energy by reducing power consumption that may otherwise be attributable to unnecessarily monitoring and/or decoding a system information message and/or a paging indication.

As used herein, “legacy UE” may refer to a UE that does not support a given feature. For example, a legacy UE may not be capable of interpreting signaling relating to the given feature. As another example, a legacy UE may not activate the given feature. In the context of PRACH adaptation, a legacy UE may be a UE that is not capable of performing or is not configured to perform PRACH adaptation. For example, signaling relating to PRACH adaptation (such as PRACH adaptation information) may not be readable by a legacy UE.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

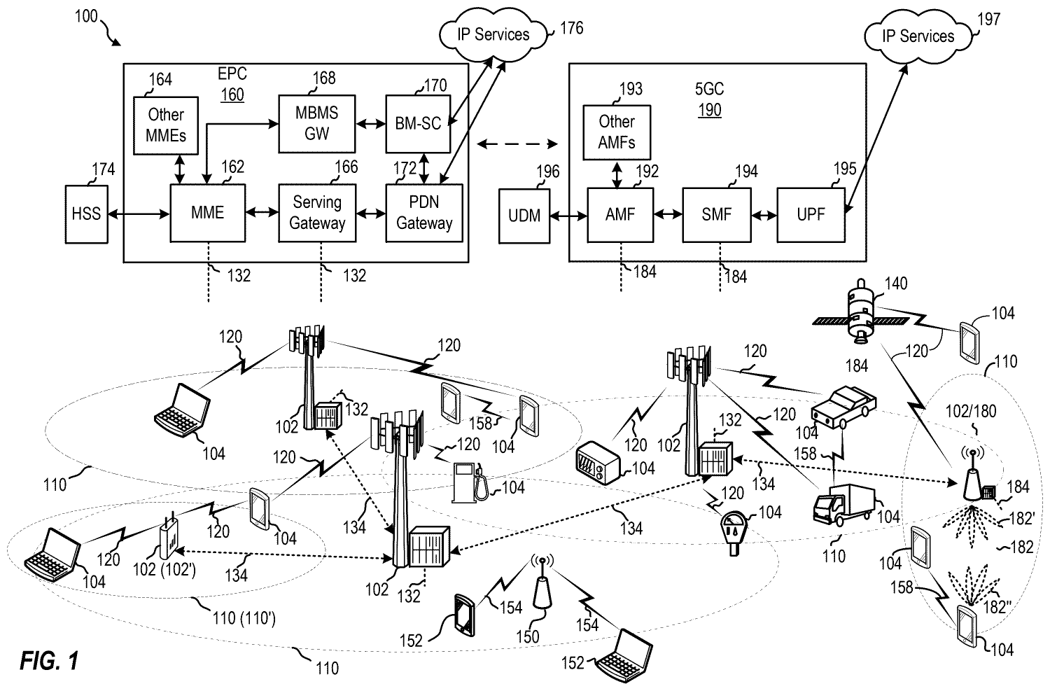

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

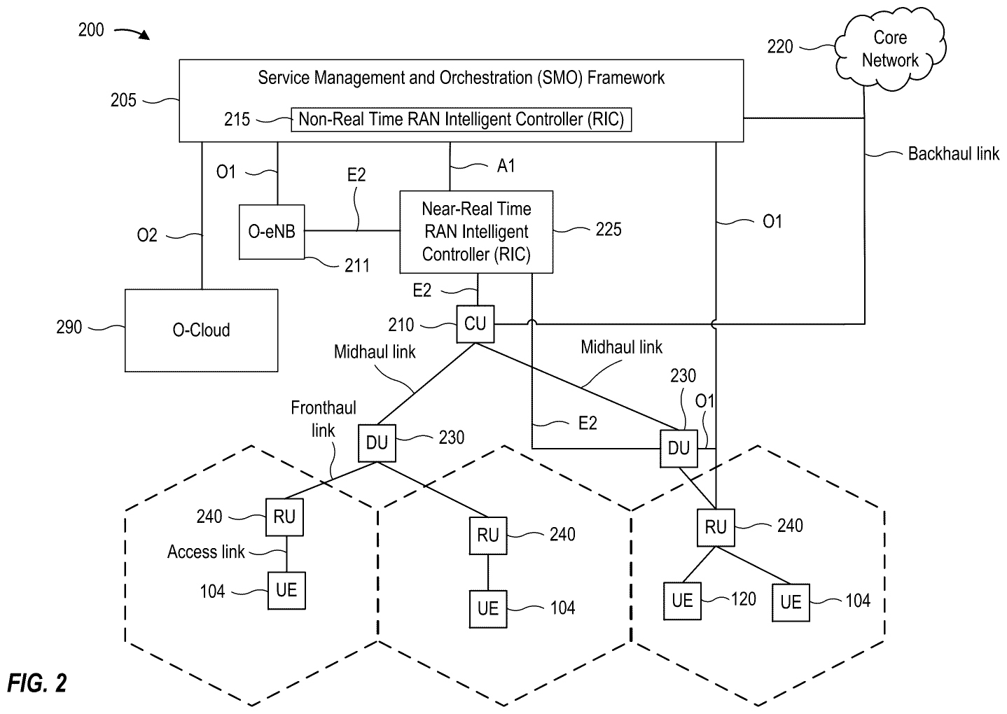

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit—User Plane (CU-UP)), control plane functionality (e.g., Central Unit—Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

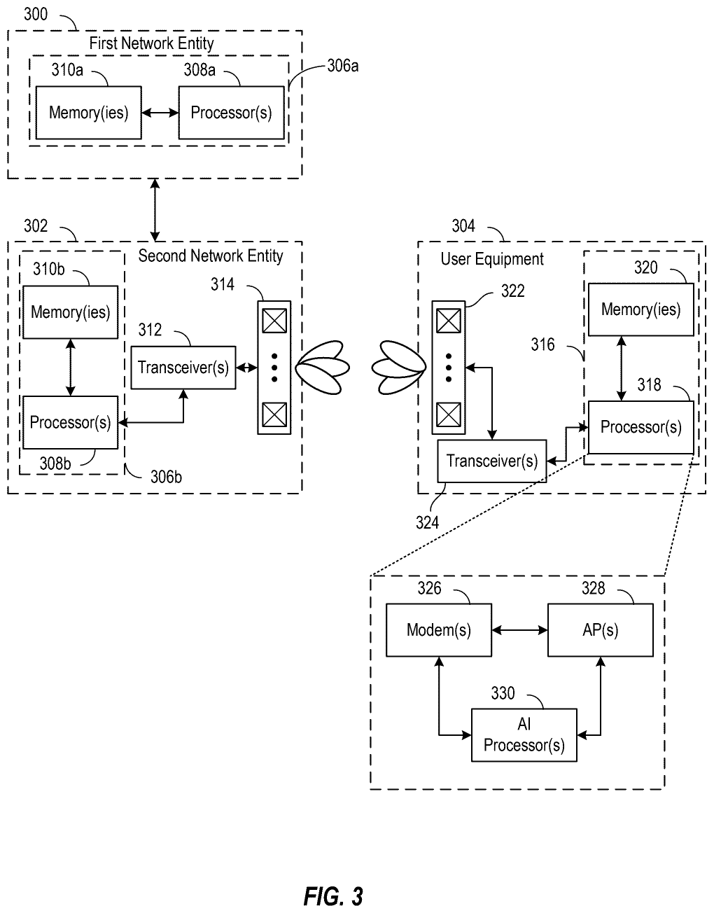

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

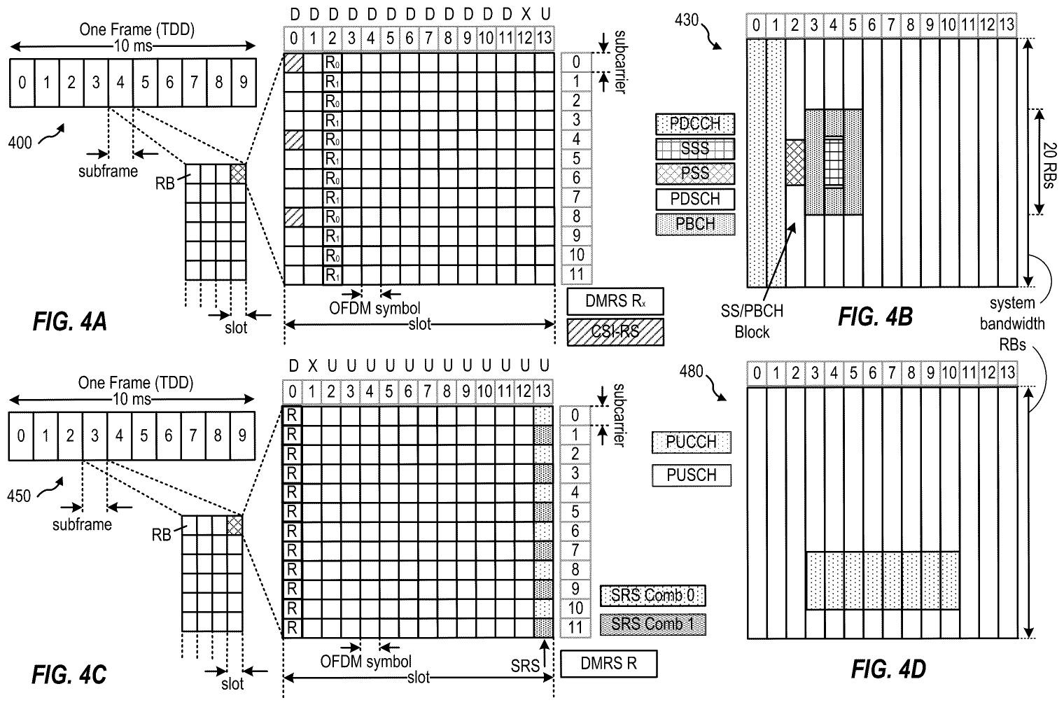

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2 slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2μ×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Random Access Procedures

Certain wireless communications systems (e.g., a 5G NR system and/or any future wireless communications system) may provide a specified channel for random access, such as a random access channel (RACH), and corresponding random access procedure(s). As discussed above, random access procedure may be performed for any of various events including, for example, initial access from an idle state (e.g., RRC idle), RRC connection re-establishment, handover, downlink (DL) and/or uplink (UL) data arrival (e.g., when the UE is in an idle state), or device positioning.

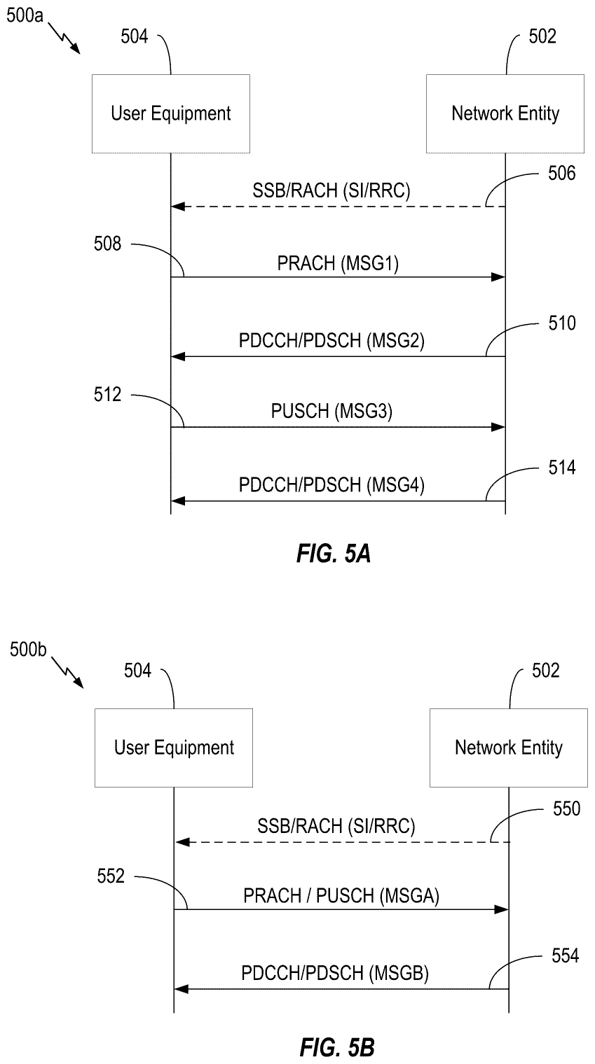

FIG. 5A depicts a process flow diagram of an example four-step RACH procedure 500a performed between a UE 504 and a network entity 502. In some aspects, the UE 504 is the UE 104 of FIG. 1 or the UE 304 of FIG. 3, and the network entity 502 is the BS 102 of FIG. 1, a disaggregated base station depicted and described with respect to FIG. 2, or the first network entity 300 or the second network entity 302 of FIG. 3.

The RACH procedure 500a may optionally begin at 506, where the network entity 502 broadcasts and the UE 504 receives a random access configuration, for example, in system information (SI) within a synchronization signal block (SSB), or within an RRC message. The random access configuration may indicate or include one or more parameters for random access communications, such as defining the RACH, the total number of random access preambles (e.g., preamble sequences) available for random access, power ramping parameters, response window size (duration), etc. In certain aspects, the UE 504 may obtain a plurality of random access configurations.

At 508, the UE 504 sends a first message (MSG1) to the network entity 502 on a physical random access channel (PRACH). In some cases, a PRACH may be referred to as a RACH. In certain aspects, MSG1 may indicate or include a RACH preamble. The RACH preamble may be or include a preamble sequence (e.g., a Zadoff Chu sequence). For contention-based random access, the preamble sequence may be randomly selected among a set of preamble sequences (e.g., up to 64 sequences, in some cases). The preamble sequence may be used to identify the UE 504 for scheduling communications (e.g., MSG2 and MSG3) with the network entity. In certain aspects, terms such as “RACH preamble,” “random access preamble,” “preamble,” “preamble sequence,” “sequence,” and the like may be used interchangeably.

At 510, the network entity 502 may respond with a random access response (RAR) message (MSG2). For example, the network entity 502 may send a PDCCH communication including downlink control information (DCI) that schedules the RAR on the PDSCH. The RAR may include, for example, certain parameters used for an uplink transmission such as a random access (RA) preamble identifier (RAPID), a timing advance, an uplink (UL) grant (e.g., indicating one or more time-frequency resources for an uplink transmission), cell radio network temporary identifier (C-RNTI), and/or a backoff parameter value. The RAPID may correspond to the preamble sequence and indicate that the RAR is for the UE 504 that transmitted MSG1 at 506. The backoff parameter value may be used to determine a RACH occasion (RO) for sending a subsequent RACH transmission (e.g., a preamble transmission). A RACH occasion may correspond to one or more time-frequency resources available for transmitting a preamble in a RACH.

At 512, in response to MSG2, the UE 504 transmits a third message (MSG3) to the network entity 502 on the PUSCH. In some aspects, MSG3 may include an RRC connection request, a tracking area update (e.g., for UE mobility), and/or a scheduling request (for an UL transmission). As an example, MSG3 is communicated in the time-frequency resource(s) indicated in the UL grant of the RAR.

At 514, the network entity 502 may send a contention resolution message (MSG4) in response to MSG3. The network entity 502 may send a downlink scheduling command (e.g., DCI), which is addressed to a specific UE identity associated with the UE 504 as discussed below, via the PDCCH. The network entity 502 may send a UE contention resolution identity (e.g., a medium access control element) via the PDSCH according to the downlink scheduling command. In certain cases, multiple UEs may send the same preamble in the same RO. As the network entity 502 may not be able to identify which UE sent which preamble, the network entity 502 may reply with a single RAR associated with the preamble. The MSG3 may include or indicate a specific UE identity associated with the UE 504, such as a radio network temporary identifier (RNTI) or a temporary mobile subscriber identity (TMSI). The network entity 502 may decode MSG3 and determine the UE identity associated with at least one of the UEs (e.g., UE 504). MSG4 may be addressed to the UE identity (e.g., the RNTI or an RNTI based on the TMSI) associated with the MSG3 that the network entity was able to successfully decode. For example, the MSG4 may be scrambled by the RNTI associated with the MSG3. If the UE 504 obtains the same identity sent in MSG3, the UE 504 concludes that the random access procedure succeeded. In some cases, if the UE 504 is unable to obtain or decode MSG3 and/or MSG4, the UE 504 may repeat the RACH procedure, such as the four-step RACH procedure 500a.

In some cases, to reduce the latency associated with random access, a two-step RACH procedure may be used. As the name implies, the two-step RACH procedure may effectively consolidate the four messages of the four-step RACH procedure into two messages.

FIG. 5B depicts a process flow diagram of an example two-step RACH procedure 500b performed between the UE 504 and the network entity 502.

The RACH procedure 500b may optionally begin at 550, where the network entity 502 broadcasts and the UE 504 receives a random access configuration, for example in system information within a synchronization signal block, or within an RRC message.

At 552, the UE 504 sends a first message (MSGA) to the network entity 502, which may effectively combine MSG1 and MSG3 described above with respect to FIG. 5A. In some aspects, MSGA includes a RACH preamble for random access and a payload. For example, the payload may include a UE-ID and other signaling information, such as a buffer status report or scheduling request. The RACH preamble of MSGA may be transmitted over the PRACH, and the payload of MSGA may be transmitted over the PUSCH, for example.

At 554, the network entity 502 may send a random access response message (MSGB), which may effectively combine MSG2 and MSG4 described above, via the PDCCH and PDSCH. For example, MSGB may include a RAPID, a timing advance, a backoff parameter value, a contention resolution message, an uplink and/or downlink grant, and transmit power control commands.

### Aspects Related to SSB to RO Mapping Random Access Configurations

In certain aspects, an RO (and/or a preamble) is associated with a specific SSB, for example, to help distribute random access communications across the ROs. As an example, a UE may measure the signal strength associated with multiple SSBs and select an SSB that has a signal strength above a certain threshold (e.g., a threshold reference signal received power (RSRP)). If none of the SSBs have a signal strength above the threshold, the UE may select any SSB among the candidate SSBs. Then, the UE may select a preamble belonging to (or associated with) the selected SSB. For example, a subset of preambles may be associated with a specific SSB. Thus, the preamble may indicate the SSB selected by the UE. Further, every SSB communicated by a network entity may be mapped to (or associated with) a specific RO. In some cases, multiples SSBs may be mapped to a single RO. The UE selects an RO associated with the selected SSB, and the UE may send the preamble in the selected RO as discussed herein with respect to FIGS. 5A and 5B. Accordingly, the SSB selection distributes preamble transmissions across the candidate ROs as the RO selection depends on the SSB selection. The association between an RO/preamble and an SSB allows a network entity to apply the same transmit beamforming as the SSB when sending the MSG2 transmission as discussed herein with respect to FIGS. 5A and 5B. Thus, the indication of the SSB selection with the preamble transmission conveys transmit beamforming information to the network entity.

In certain aspects, one or more sets of parameters may be obtained by a UE, such as UE 104 of FIG. 1, from a network entity for random access communications. For example, the one or more sets of parameters may include a first set of parameters and a second set of parameters, for example, for dynamic configuration of random access communications. In some aspects, the first set of parameters may be an active set of parameters being used currently at or by the network entity. In some cases, the second set of parameters may be an alternative set of parameters that can be activated or triggered for use. The first set of parameters and the second set of parameters may indicate an SSB to RO mapping. For example, each of the first set of parameters and the second set of parameters may include or indicate a random access configuration index (e.g., prach-ConfigurationIndex) that indicates a specific row of parameters in one or more look-up tables that define multiple SSB to RO mappings, where each row of parameters may indicate a different SSB to RO mapping.

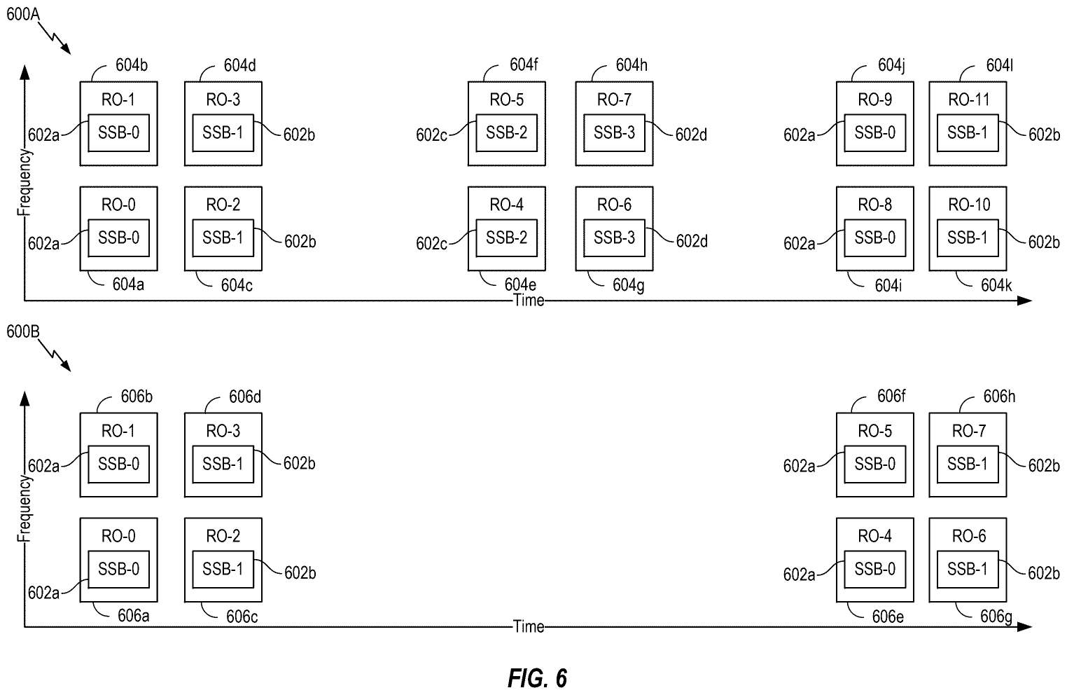

FIG. 6 illustrates example mappings 600A, 600B of SSBs to ROs for a first set of parameters (e.g., a currently active set of parameters) and a second set of parameters (e.g., an alternative set of parameters) in the time-frequency domains, respectively. In this example, there are a total of four SSBs 602a-d communicated by a network entity, and a frequency division multiplexing (FDM) number is set to two, which allocates two FDM ROs in a time instance of a single RO. The second set of parameters are configured to allow certain ROs associated with the second set of parameters to overlap in time and frequency resources with a subset of the ROs associated with the first set of parameters.

The first mapping 600A has a total of twelve ROs 604a-l, and the second mapping 600B has a total of eight ROs 606a-h. The first mapping 600A maps the first SSB 602a to the first RO 604a and the second RO 604b. The second SSB 602b is mapped to the third RO 604c and the fourth RO 604d, and so on for the subsequent SSBs 602c, 602d and the ROs 604e-l.

The second mapping 600B may follow the first mapping 600A where the respective ROs overlap in time-frequency resources. For example, the first four ROs 606a-d of the second mapping 600B may have the same SSB to RO mapping as the first mapping 600A in the first four ROs 604a-d. The second mapping 600B lacks ROs that overlap with the fifth RO 604e through the eighth RO 604h of the first mapping 600A. The fifth RO 606e of the second mapping 600B may follow the SSB to RO mapping of the ninth RO 604i of the first mapping 600A, and so on for the sixth RO 606f through the eighth RO 606h of the second mapping 600B. For example, the sixth RO 606f through the eighth RO 606h of the second mapping 600B may apply the same SSB to RO mapping as the ninth RO 604i through the twelfth RO 604l of the first mapping 600A, respectively. That is, the second mapping 600B may apply, for each of the ROs 606a-g, the same SSB to RO mapping as an RO of the first mapping 600A that overlaps in time and frequency with the respective RO 606a-g of the second mapping 600B. In other words, the second mapping 600B may be considered to apply the same SSB to RO mapping as the first mapping 600A. However, the second mapping 600B may effectively use virtual ROs that are not used for communications and fill in any missing ROs with respect to the first set of parameters for purposes of forming an SSB to RO mapping for the second set of parameters that follows the SSB to RO mapping for first set of parameters. Accordingly, the first set of parameters may effectively indicate the SSB to RO mapping (e.g., the second mapping 600B) for the second set of parameters. For example, the first set of parameters may indicate a mapping (e.g., the second mapping 600B) that indicates the first RO 606a is associated with the first SSB 602a, and so on for the other ROs 606b-h and SSBs 602a-d.

Note that the mappings depicted in FIG. 6 are examples. Other suitable SSB to RO mappings may be applied to the first set of parameters and/or the second set of parameters, for example, to enable dynamic configuration of random access communications.

### Example Signaling for RACH Configuration Adaptation During a RACH Procedure

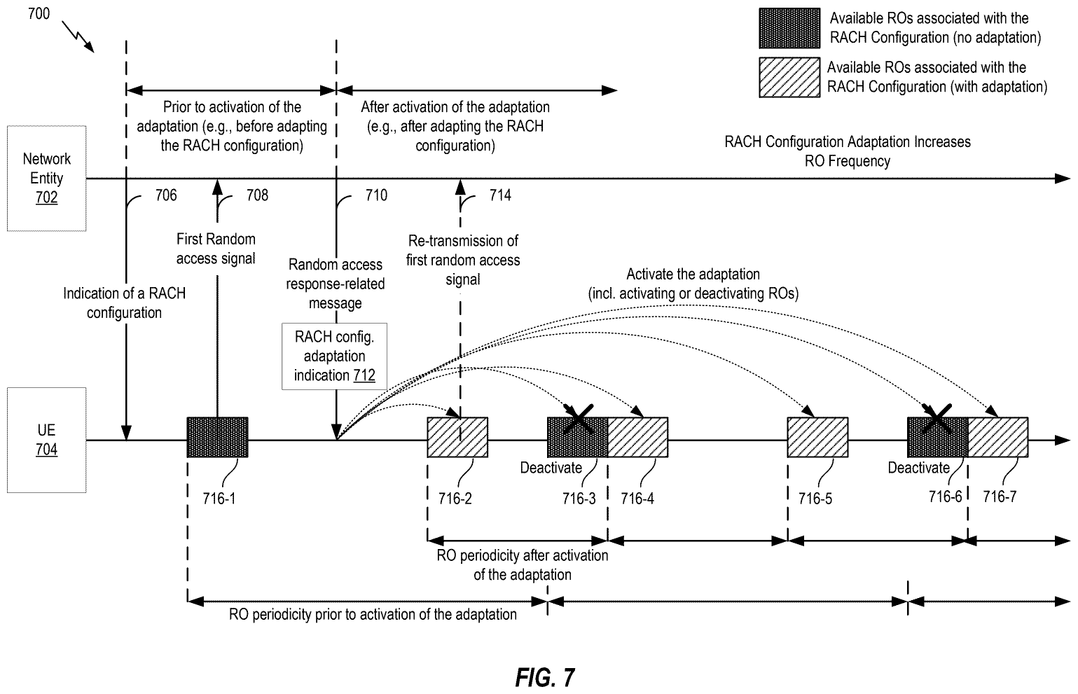

FIG. 7 depicts a process flow 700 for communications in a network between a network entity 702 and a UE 704. In certain aspects, the network entity 702 may be an example of the BS 102 of FIG. 1, the first network entity 300 or the second network entity 302 of FIG. 3, or a disaggregated base station depicted and described with respect to FIG. 2. Similarly, the UE 704 may be an example of UE 104 of FIG. 1 or the UE 304 of FIG. 3. However, in other aspects, UE 704 may be another type of wireless communications device and network entity 702 may be another type of network entity or network node. Note that any operations or signaling illustrated with dashed lines may indicate that that operation or signaling is an optional or alternative example.

Signaling in process flow 700 of FIG. 7 may be performed to adapt a RACH configuration identifying ROs corresponding to time-frequency resources configured for random access communications. In certain aspects, as shown in process flow 700 of FIG. 7, the RACH configuration may be adapted such as to activate new ROs or deactivate ROs associated with an original RACH configuration. In process flow 700 of FIG. 7, the RACH configuration adaptation may increase a frequency of ROs configured for random access communications, such as for communicating a subsequent random access signal after a RACH procedure has been initiated. In other scenarios, a RACH configuration adaptation may occur to reduce a frequency of ROs configured for random access communications, such as for communicating the subsequent random access signal after a RACH procedure has been initiated.

At 706, network entity 702 sends, to UE 704, an indication of a RACH configuration. The RACH configuration may identify three ROs (e.g., RO 716-1, RO 716-3, and RO 716-6) corresponding to time-frequency resources configured for random access communications. For example, the RACH configuration may be associated with RO 716-1, RO 716-3, and RO 716-6, which have a first RO periodicity (e.g., shown as the RO periodicity prior to activation of the adaptation in FIG. 7). UE 704 may use RO 716-1, RO 716-3, and/or RO 716-6 for sending a random access signal to initiate a RACH procedure with network entity 702, and may map SSBs to ROs 716-1, 716-3, and 716-6.

At 708, UE 704 determines to initiate a first RACH procedure with network entity 702. Thus, UE 704 sends, to network entity 702, a first random access signal. In certain aspects, the first random access signal is a first message (MSG1) sent on a PRACH during a four-step RACH procedure, such as the first message (MSG1) sent at 508 in RACH procedure 500a of FIG. 5A. In certain aspects, the first random access signal is a first message (MSGA) sent on a PRACH during a two-step RACH procedure, such as the first message (MSGA) sent at 552 in RACH procedure 500b of FIG. 5B. In this example, UE 704 sends, to network entity 702, the first random access in RO 716-1, which is an RO associated with the RACH configuration received at 706.

At 710, network entity 702 sends, to UE 704, a random access response-related message corresponding to the first random access signal communicated at 708. The random access response-related message may include a RACH configuration adaptation indication 712.

In certain aspects, the random access response-related message is a RAR message (MSG2) sent during a four-step RACH procedure, such as the RAR message (MSG2) sent at 510 in RACH procedure 500a of FIG. 5A. In certain aspects, the random access response-related message comprises DCI scheduling a RAR message (MSG2) sent during a four-step RACH procedure. In certain aspects, the RACH configuration adaptation indication 712 is specified by one or more bits of a payload of the RAR message (e.g., bit(s) of the MSG2 payload).

In certain aspects, the random access response-related message is a RAR message (MSGB) sent during a two-step RACH procedure, such as the RAR message (MSGB) sent at 554 in RACH procedure 500b of FIG. 5B. In certain aspects, the random access response-related message comprises DCI scheduling a RAR message (MSGB) sent during a two-step RACH procedure. In certain aspects, the RACH configuration adaptation indication 712 is specified by one or more bits of a payload of the RAR message (e.g., bit(s) of the MSGB payload).

The RACH configuration adaptation indication 712 may be an indication of an activation of an adaptation associated with one or more ROs. For this example, the RACH configuration adaptation indication 712 may be an indication of an activation of an adaptation associated with six ROs, e.g., RO 716-2, RO 716-3, RO 716-4, RO 716-5, RO 716-6, and RO 716-7. Two of the ROs associated with the adaptation (e.g., indicated to be activated by the RACH configuration adaptation indication 712), such as RO 716-3 and RO 716-6, are also associated with the RACH configuration (e.g., the original RACH configuration indicated to UE 704 at 706). In this example, the adaptation may (1) activate RO 716-2, RO 716-4, RO 716-5, and RO 716-7, and (2) deactivate RO 716-3 and RO 716-6 (as shown in FIG. 7). Thus, when the adaptation is activated (and where the RACH configuration adaptation indication 712 indicates such activation), RO 716-2, RO 716-4, RO 716-5, and RO 716-7 may be activated (e.g., added to the RACH configuration for subsequent random access communications, such as within a limited period of time). Further, when the adaptation is activated (and where the RACH configuration adaptation indication 712 indicates such activation), RO 716-3 and RO 716-6 may be deactivated (e.g., muted in the RACH configuration, where they are unable to be used for subsequent random access communications, such as within a limited period of time). Put differently, in this example, the original RACH configuration (e.g., indicated to UE 704 at 706), associated with RO 716-1, RO 716-3, and RO 716-6, may be replaced by a new RACH configuration (e.g., the adapted RACH configuration), associated with RO 716-2, RO 716-4, RO 716-5, and RO 716-7. ROs of the new RACH configuration may have a second RO periodicity (e.g., shown as the RO periodicity after to activation of the adaptation in FIG. 7). The second RO periodicity may be less than the first RO periodicity associated with the original RACH configuration, such that the RACH configuration adaptation indication 712 increases the RO frequency.

This increase in RO frequency may enable the UE to send a re-transmission of the first random access signal or a second random access signal to initiate a second RACH procedure more frequently with the adapted (e.g., new) RACH configuration than with the original RACH configuration. For example, UE 704 may send, to network entity 702 at 714, a re-transmission of the first random access signal using an RO associated with the adapted RACH configuration. Specifically, in the example shown in FIG. 7, UE 704 may use RO 716-2, associated with the adapted (e.g., new) RACH configuration to send a re-transmission of the first random access signal. Alternatively, in certain aspects, UE 704 may send, to network entity 702 at 714, a second random access signal to initiate a second RACH procedure using one of the RO(s) associated with the adapted (e.g., new) RACH configuration (not shown in FIG. 7).

While, in FIG. 7, the activation of the adaptation (e.g., based on network entity 702 sending, at 710, the random access response-related message including the RACH configuration adaptation indication 712 of activation of the adaptation) results in an increase in the RO frequency, in some other examples, an activation of an adaptation may result in a reduction in the RO frequency (e.g., reduction in the frequency of ROs that UE 704 may use during a period of time for sending a random access signal).

Although FIG. 7 depicts the example use of a RACH configuration adaptation indication to change RO periodicity, in some other examples, a RACH configuration adaptation indication may be used to more generally cause any change to the configured ROs, such as including adding (e.g., activating) one or more ROs and/or muting one or more ROs (e.g., deactivating).

In certain aspects (although not shown in FIG. 7), UE 704 may receive an indication of a plurality of indexes associated with a plurality of adaptations prior to receiving the random access response-related message at 710 in FIG. 7. In certain aspects, UE 704 receives the indication of the plurality of indexes in one or more system information (SI) messages. In certain aspects, UE 704 receives the indication of the plurality of indexes via RRC signaling (e.g., an RRC configuration).

Each index, in the plurality of indexes received at UE 704, may be associated with an adaptation for a respective set (e.g., one or more) of ROs. For example, a first index may be associated with a first adaptation and a second index may be associated with a second adaptation. The first adaptation may be associated with four ROs, and may be used to deactivate and/or activate each of the four ROs when activated. The second adaptation may be associated with six different ROs, and may be used to deactivate and/or activate each of the six ROs when activated. In certain aspects, the RACH configuration adaptation indication 712 (e.g., included in the random access response-related message sent by network entity 702 at 710) may comprise an indication of one of the indexes sent to UE 704, such as the first index. Based on receiving the RACH configuration adaptation indication 712, or more specifically the first index, UE 704 may determine that the first adaptation is associated with the first index, and accordingly adapt the RACH configuration according to the first adaptation. Put differently, sending the plurality of indexes to the UE 704 prior to when an adaptation is needed (e.g., to activate and/or deactivate RO(s)), may allow for an adaptation to be indicated to the UE 704 via an index. Indicating the index to the UE 704, via the random access response-related message, may activate an adaptation, such that the RACH configuration is adapted to a pre-indicated configuration. Less bits may be used to send the random access response-related message with the index than when sending the random access response-related message with an adaptation for a detailed RACH configuration, thereby reducing transmission overhead for RACH configuration adaptation.

Note that the process flow 700 illustrated in FIG. 7, is described herein to facilitate an understanding of RACH configuration adaptation, and aspects of the present disclosure may be performed in various manners via alternative or additional signaling and/or operations. In certain aspects, the operations and/or signaling of FIG. 7 may occur in an order different from that described or depicted, and various actions, operations, and/or signaling may be added, omitted, or combined.

### Example Signaling for PEI

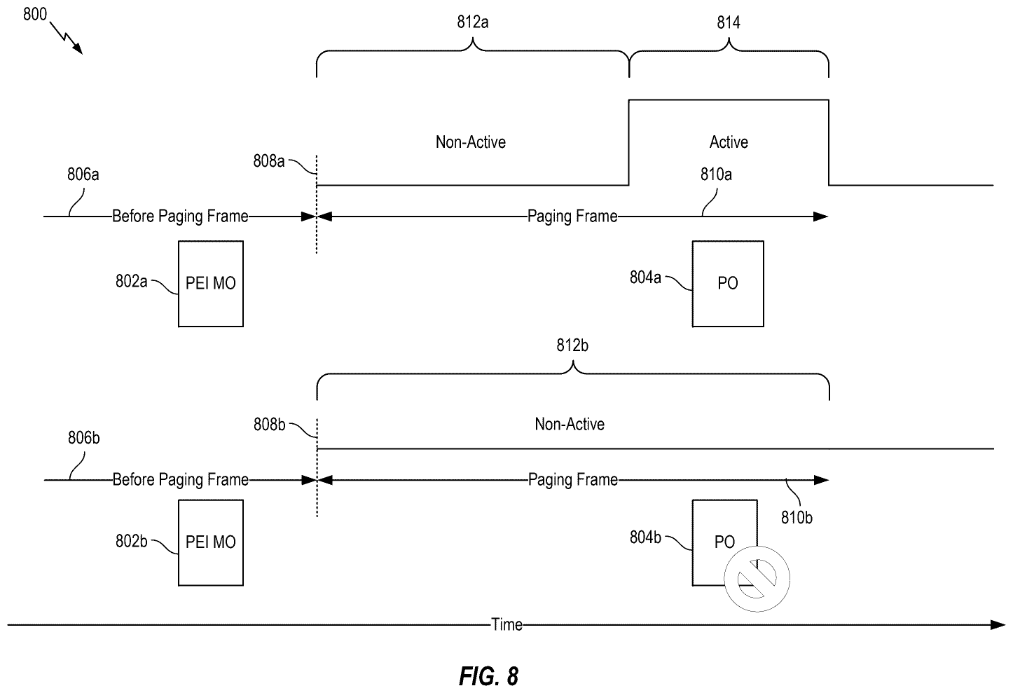

FIG. 8 depicts an example 800 of signaling for a paging cycle.

Paging is a mechanism for efficiently notifying a UE of incoming calls, data, or system information updates when the UE is in an idle or inactive mode. A UE may monitor for a paging message (such as a paging downlink control information (DCI) message) on a paging monitoring occasion (MO). A paging MO is a specific time interval during which a UE wakes up from a low-power state to check for paging messages from the network. These paging MOs are configured based on various parameters, including the UE's identity, the number of paging frames per paging cycle, and the number of paging occasions per paging frame. By synchronizing these paging MOs between the network and the UE, power consumption is reduced as the UE only needs to monitor for paging messages during these predetermined intervals.

Paging early indication (PEI) is an enhancement to the paging mechanism. PEI is designed to further improve UE power efficiency and reduce latency. A PEI message provides a preliminary notification to the UE about an upcoming paging message, allowing the UE to prepare for the full paging message reception or skip monitoring of a paging MO if no paging message is upcoming. By implementing PEI, UEs can make more informed decisions about whether to fully wake up and process the subsequent paging message, potentially leading to substantial power savings and improved responsiveness. A UE may monitor for a PEI message in a configured resource referred to as a PEI MO. It may be optional for a UE to monitor a PEI MO.

Paging MOs and PEI MOs may generally be semi-statically configured, such as via RRC signaling or system information broadcast. In some examples, one or more of these occasions may be configured for a large number of UEs.

Referring to the example of FIG. 8, first PEI MO 802a is an MO during which a UE may receive a PEI indicative of a need to monitor first PO 804a, and second PEI MO 802b is an MO during which a UE may receive a PEI indicating that there is no need to monitor second PO 804b. As depicted in the example 800 of FIG. 8, the first PEI MO 802a and the second PEI MO 802b are configured for a portion of time 806a, 806b before the start 808a, 808b of paging frames 810a, 810b. During first portions 812a, 812b of the paging frames 810a, 810b where no PO is configured, the UE may be in a non-active mode, such as in an idle or inactive mode. During a second portion 814 of the paging frame 810a where the first PO 804a is configured, the UE may go into an active mode to monitor for a paging message during the first PO 804a since the first PEI MO 802a indicates to monitor for the paging message during the first PO 804a. Note that the UE remains in the non-active mode throughout the first portion 812b of the paging frame 810b, which may include an entirety of the paging frame 810b. Thus, power is conserved using the PEI MOs 802.

### Example Operations of Indication of Additional PRACH Availability

Aspects of the present disclosure provide apparatuses, methods, processing systems, and computer-readable mediums for indication of additional PRACH availability. In particular, for certain wireless communications systems, such as 5G NR systems and/or future wireless communications technologies, certain aspects provide for a device, such as a UE, to receive a message that includes PRACH adaptation information and to perform a RACH procedure based on the PRACH adaptation information. The PRACH adaptation information may include an indication of the additional PRACH availability. In some aspects, the PRACH adaptation information may be included in one of: one or more reserved bits of a message (such as a paging DCI message) received by a UE, or a PEI. For example, the one or more reserved bits of the message may be readable by a UE in association with a first radio access technology and not by another UE in association with a second radio access technology. For example, the second radio access technology may be an earlier generation-based release, and the first radio access technology may be a later generation-based release, where UEs supporting the first radio access technology can read information that is structured according to the second radio access technology, but UEs supporting only the second radio access technology may be unable to read information that is structured according to the first radio access technology (such as reserved bits). Note that “PRACH adaptation information,” as used herein, can refer either to information identifying additional PRACH availability (or another PRACH adaptation) or to information that indicates where a UE can obtain the information identifying the additional PRACH availability (or other PRACH adaptation). In certain aspects, a UE in association with an earlier generation-based release may be a legacy UE that does not support a given feature, such as a feature supported for a later generation-based release.

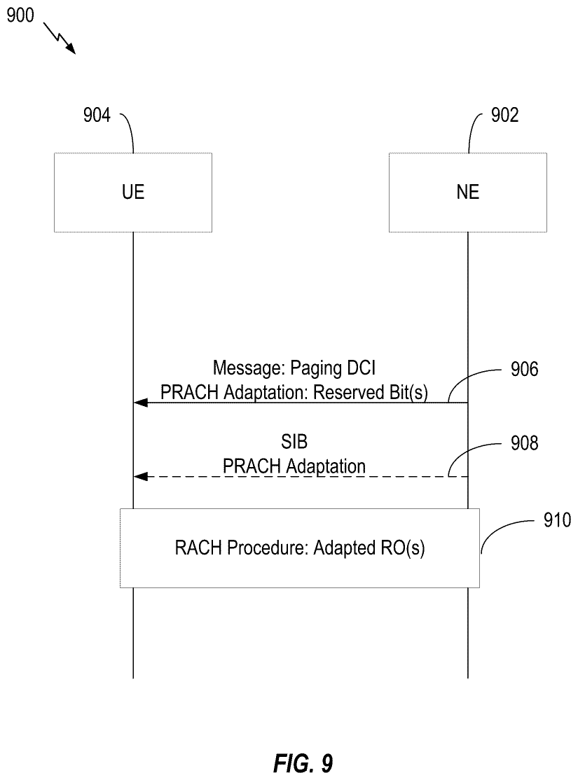

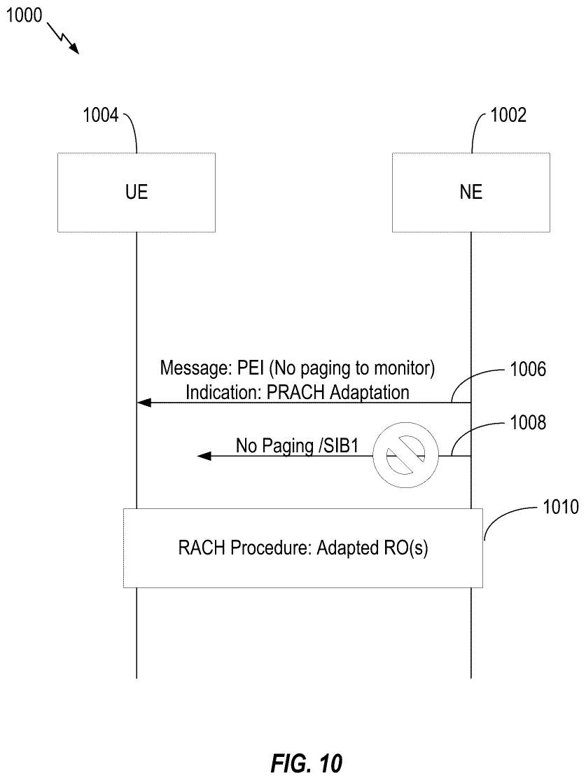

FIG. 9 depicts a process flow 900 for communications in a wireless communications network between a network entity 902 and a UE 904 to communicate PRACH adaptation information related to an indication of additional PRACH availability. In some aspects, the UE 904 is the UE 104 of FIG. 1 or the UE 304 of FIG. 3, and the network entity 902 is the BS 102 of FIG. 1, a disaggregated base station depicted and described with respect to FIG. 2, or the first network entity 300 or the second network entity 302 of FIG. 3. While the techniques of FIGS. 9 and 10 are described with regard to indication of additional PRACH availability, these techniques can readily be applied for any sort of PRACH adaptation, such as the PRACH adaptations described with regard to FIG. 7. The UE 904 may support PRACH adaptation (e.g., according to a later generation-based release of a radio access technology). For example, the UE 904 may be a NES-capable UE.

As depicted, network entity 902 sends a message to UE 904 at 906. In some aspects, the message may be a paging DCI message, including the PRACH adaptation information related to the indication of additional PRACH availability in one or more reserved bits. The PRACH adaptation information may include an indication of a change in an activation state for PRACH adaptation. For example, in certain aspects, the indication of the change in the activation state for PRACH adaptation may be associated with an indication included in a system information message such as SIB1. That is, the message at 906 may indicate, via one or more reserved bits, that system information associated with the network entity 902 has changed, and a corresponding system information message may indicate a change with regard to an activation state for PRACH adaptation. For example, the one or more reserved bits may indicate that the system information associated with the network entity 902 has changed only with regard to an activation state for PRACH adaptation. In some aspects, the PRACH adaptation may be an adaptation of additional PRACH resources that are only applicable for UE 904 (e.g., NES-capable UEs) but not for legacy UEs. Thus, it is beneficial that the one or more reserved bits of the paging DCI message are readable by UE 904 but not by legacy UEs, since these certain UEs may be the same UEs that benefit from the adaptation of the additional PRACH resource. The one or more reserved bits of the paging DCI message may cause the UE 904 to receive a system information message, such as a SIB, in response to receiving the paging DCI message.

Accordingly, a legacy UE that does not read or decode the one or more reserved bits of the paging DCI message may not receive any SIB at 908. For example, the paging DCI message may include one or more fields that indicate no change in system information associated with the network entity 902, and a legacy UE may decode the one or more fields from the paging DCI message. Since the UE 904 is a UE that is implemented with a later generation-based release of a radio access technology and is able to read and decode the one or more reserved bits, the UE 904 may receive the SIB at 908 to obtain the change in the activation state for PRACH adaptation, such as related to an adaptation of additional PRACH resources, and perform a RACH procedure at 910 accordingly, during one or more adapted ROs. The RACH procedure is generally described herein with respect to FIGS. 5A and 5B.

Thus, aspects of the present disclosure enable additional PRACH availability indication, which is applicable for only compatible UEs such as NES-capable UEs, and not for legacy UEs, to be communicated to the UE 904 in a way that properly communicates the additional PRACH availability indication to such compatible UEs while saving energy for legacy UEs. That is, aspects of the present disclosure allow such compatible UEs to properly receive and decode, via a system information message such as a SIB and based on a paging DCI message that includes an indication of a need to receive the SIB, information related to additional PRACH resources and perform a RACH procedure in accordance with the additional PRACH resources. Further, since the legacy UEs do not read the same information from the paging DCI message as described above, the legacy UEs are not triggered to receive and decode any SIB based on the same paging DCI message, such that the legacy UEs do not need to unnecessarily expend energy to receive and decode a SIB that would not include any relevant information for the legacy UEs.

FIG. 10 depicts an example 1000 of communications in a wireless communications network between a network entity 1002 and a UE 1004 to communicate PRACH adaptation information related to an indication of additional PRACH availability. In some aspects, the UE 1004 is the UE 104 of FIG. 1 or the UE 304 of FIG. 3, and the network entity 1002 is the BS 102 of FIG. 1, a disaggregated base station depicted and described with respect to FIG. 2, or the first network entity 300 or the second network entity 302 of FIG. 3. The UE 1004 may support PRACH adaptation (e.g., according to a later generation-based release of a radio access technology).

As depicted, network entity 1002 sends a message to UE 1004 at 1006. In some aspects, the message may be a PEI message, indicating that there is no paging in a corresponding PO to monitor. “PEI message” and “PEI” may be used interchangeably herein. In certain aspects, the PEI message may include PRACH adaptation information that includes an indication of an additional PRACH availability. For example, PRACH adaptation information, such as an indication of additional PRACH availability, included in the PEI message received at 1006 may be based on a PEI radio network temporary identifier (PEI-RNTI). The PEI-RNTI may be associated with an indication of a change in an activation state for PRACH adaptation and readable only by certain UEs, such as NES-capable UEs, but not by legacy UEs. For example, a first PEI-RNTI may be associated with a first change in an activation state, a second PEI-RNTI may be associated with a second change in the activation state, and so on, and a NES-capable UE may determine which change in activation state is indicated according to which PEI-RNTI is received. In some aspects, the PEI-RNTI may be used to scramble the PEI message or a part of the PEI message, such as a cyclic redundancy check (CRC) of the PEI message, and this scrambled content may be the PRACH adaptation information.

In certain aspects, the PEI message received at 1006 may include all information that is needed for the UE 1004 to perform a RACH procedure with the network entity 1002 in accordance with the additional PRACH availability. For example, the PEI message may include the PRACH adaptation information, which may explicitly identify the additional PRACH availability. Then, the UE 1004 may perform a RACH procedure in accordance with the additional PRACH availability at 1010 without waking up for a PO, and without receiving and decoding any system information message, thereby saving energy.

In certain aspects, the PEI message may indicate that there is no paging DCI message to monitor, and PRACH adaptation information in the PEI message may indicate that an indication of an additional PRACH availability is provided in system information. Thus, both a legacy UE and the UE 1004 may skip monitoring or decoding of the paging DCI message. Furthermore, the legacy UE may skip reception of system information that carries the indication of additional PRACH availability, and the UE 1004 may receive the system information (without decoding the paging DCI message) to obtain the indication of additional PRACH availability.

As mentioned, in certain aspects, the PEI message may include one or more fields that indicate that there is no paging to monitor in a corresponding PO. As the PEI-RNTI may not be readable by legacy UEs, if the UE 1004 is a legacy UE, the UE 1004 may, at 1008, also avoid unnecessarily waking up to receive a paging message such as a paging DCI message described with respect to FIG. 9, and accordingly unnecessarily receiving and decoding any SIB, thereby saving energy.

### Example Operations of a User Equipment

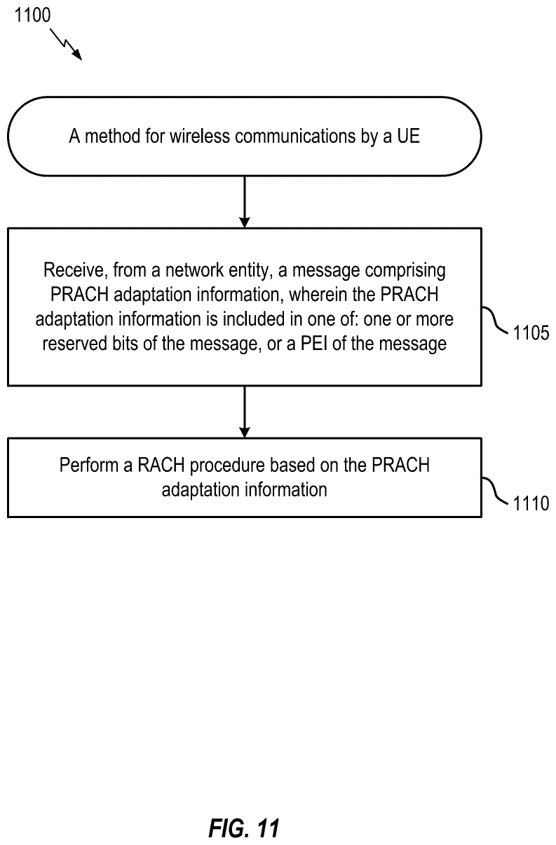

FIG. 11 shows a method 1100 for wireless communications by an apparatus, such as UE 104 of FIG. 1 or UE 304 of FIG. 3.

Method 1100 begins at block 1105 with receiving, from a network entity, a message comprising PRACH adaptation information, wherein the PRACH adaptation information is included in one of: one or more reserved bits of the message, or a PEI of the message. In some aspects, the network entity is the BS 102 of FIG. 1, a disaggregated base station depicted and described with respect to FIG. 2, or the first network entity 300 or the second network entity 302 of FIG. 3. Further, in certain aspects, block 1105 may correspond to 906 of FIG. 9 or 1006 of FIG. 10.

Method 1100 then proceeds to block 1110 with performing a RACH procedure based on the PRACH adaptation information. In some aspects, block 1110 may correspond to 910 of FIG. 9 or 1010 of FIG. 10.

In some aspects, the PRACH adaptation information comprises an indication of a change in an activation state for PRACH adaptation.

In some aspects, the indication of the change in the activation state is associated with an indication included in a system information message.

In some aspects, method 1100 further includes receiving the system information message in response to receiving the message.

In some aspects, method 1100 further includes performing the RACH procedure, based on the system information message, in accordance with the change in the activation state for the PRACH adaptation.

In some aspects, the message comprises a paging DCI message, as described with respect to FIG. 9.

In some aspects, the paging DCI message comprises one or more fields that indicate no change in system information associated with the network entity.

In some aspects, the paging DCI message indicates that system information associated with the network entity has changed only with regard to an activation state for PRACH adaptation.

In some aspects, the message comprises the PEI.

In some aspects, the PEI comprises one or more fields that indicate that there is no paging to monitor in a corresponding paging occasion.

In some aspects, the PRACH adaptation information comprises a PEI-RNTI associated with an indication of a change in an activation state for PRACH adaptation, as described with respect to FIG. 10.

In some aspects, the one or more reserved bits comprise one or more bits of the message that are readable by the UE in association with a first radio access technology and not by another UE in association with a second radio access technology. In certain aspects, the UE in association with the first radio access technology may be, for example, a UE, such as an NES-capable UE that can receive and decode information related to an additional PRACH availability indication, while the another UE in association with the second radio access technology may be a legacy UE described with respect to FIGS. 9 and 10. In some aspects, the one or more bits of the message may carry the information related to the additional PRACH availability indication, as described with respect to FIGS. 9 and 10. Accordingly, as these bits of the message are only readable by certain UEs such as NES-UEs but not by legacy UEs, aspects of the present disclosure as implemented via method 1100 saves energy for UEs, such as the legacy UEs, by enabling such UEs to avoid unnecessarily receiving and decoding any system information message, as well as avoiding unnecessarily receiving and decoding any paging message such as a paging DCI message in some cases.

In some aspects, the second radio access technology is an earlier generation-based release and the first radio access technology is a later generation-based release.

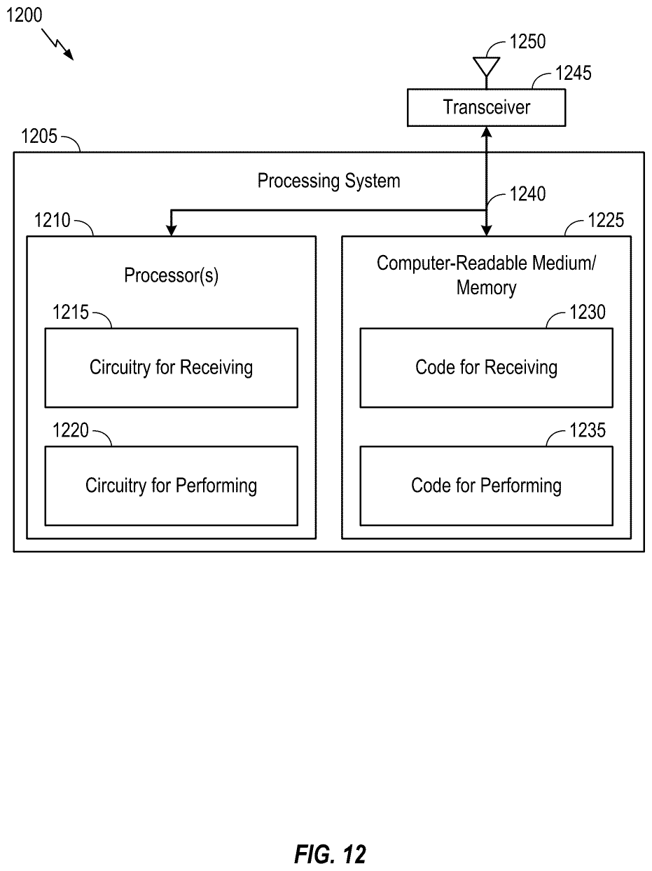

In some aspects, method 1100, or any aspect related to it, may be performed by an apparatus, such as communications device 1200 of FIG. 12, which includes various components operable, configured, or adapted to perform the method 1100. Communications device 1200 is described below in further detail.

Note that FIG. 11 is just one example of a method, and other methods including fewer, additional, or alternative operations are possible consistent with this disclosure.

### Example Communications Device

FIG. 12 depicts aspects of an example communications device 1200 configured for wireless communications. In some aspects, communications device 1200 is a user equipment, such as UE 104 described above with respect to FIG. 1 or UE 304 described with respect to FIG. 3.

The communications device 1200 includes a processing system 1205 coupled to a transceiver 1245 (e.g., a transmitter and/or a receiver). The transceiver 1245 is configured to transmit and receive signals for the communications device 1200 via an antenna 1250, such as the various signals as described herein. The processing system 1205 may be configured to perform processing functions for the communications device 1200, including processing signals received and/or to be transmitted by the communications device 1200.

The processing system 1205 includes one or more processors 1210 and a computer-readable medium/memory 1225. In various aspects, the one or more processors 1210 may be representative of the one or more processors 318 described with respect to FIG. 3. The one or more processors 1210 are coupled to a computer-readable medium/memory 1225 via a bus 1240. In some aspects, the computer-readable medium/memory 1225 may be representative of the one or more memories 320 described with respect to FIG. 3. The computer-readable medium/memory 1225 is a non-transitory computer-readable medium/memory. In certain aspects, the computer-readable medium/memory 1225 is configured to store instructions (e.g., computer-executable code), that when executed by the one or more processors 1210, cause the one or more processors 1210 to perform the method 1100 described with respect to FIG. 11, or any aspect related to it, including any operations described in relation to FIG. 11. Note that reference to a processor performing a function of communications device 1200 may include one or more processors performing that function of communications device 1200, such as in a distributed fashion.

In the depicted example, computer-readable medium/memory 1225 stores code (e.g., executable instructions), including code for receiving 1230 and code for performing 1235. Processing of the code 1230 and 1235 may enable and cause the communications device 1200 to perform the method 1100 described with respect to FIG. 11, or any aspect related to it.

The one or more processors 1210 include circuitry configured to implement (e.g., execute) the code stored in the computer-readable medium/memory 1225, including circuitry for receiving 1215 and circuitry for performing 1220. Processing with circuitry 1215 and 1220 may enable and cause the communications device 1200 to perform the method 1100 described with respect to FIG. 11, or any aspect related to it.

More generally, means for communicating, transmitting, sending or outputting for transmission may include the one or more transceivers 324, one or more antenna 322 and/or processing system 316 of the UE 304 illustrated in FIG. 3, transceiver 1245 and/or antenna 1250 of the communications device 1200 in FIG. 12, and/or one or more processors 1210 of the communications device 1200 in FIG. 12. Means for communicating, receiving or obtaining may include the one or more transceivers 324, one or more antennas 322, and/or processing system 316 of the UE 304 illustrated in FIG. 3, transceiver 1245 and/or antenna 1250 of the communications device 1200 in FIG. 12, and/or one or more processors 1210 of the communications device 1200 in FIG. 12.

### Example Clauses

Implementation examples are described in the following numbered clauses:
Clause 1: A method for wireless communications by an apparatus comprising: receiving, from a network entity, a message comprising PRACH adaptation information, wherein the PRACH adaptation information is included in one of: one or more reserved bits of the message, or a PEI of the message; and performing a RACH procedure based on the PRACH adaptation information.
Clause 2: The method of Clause 1, wherein the PRACH adaptation information comprises an indication of a change in an activation state for PRACH adaptation.
Clause 3: The method of Clause 2, wherein the indication of the change in the activation state is associated with an indication included in a system information message.
Clause 4: The method of Clause 3, further comprising: receiving the system information message in response to receiving the message; and performing the RACH procedure, based on the system information message, in accordance with the change in the activation state for the PRACH adaptation.
Clause 5: The method of any one of Clauses 1-4, wherein the message comprises a paging DCI message.
Clause 6: The method of Clause 5, wherein the paging DCI message comprises one or more fields that indicate no change in system information associated with the network entity.
Clause 7: The method of Clause 5, wherein the paging DCI message indicates that system information associated with the network entity has changed only with regard to an activation state for PRACH adaptation.
Clause 8: The method of any one of Clauses 1-7, wherein the message comprises the PEI.
Clause 9: The method of Clause 8, wherein the PEI comprises one or more fields that indicate that there is no paging to monitor in a corresponding paging occasion.
Clause 10: The method of Clause 8, wherein the PRACH adaptation information comprises a PEI-RNTI associated with an indication of a change in an activation state for PRACH adaptation.
Clause 11: The method of any one of Clauses 1-10, wherein the one or more reserved bits comprise one or more bits of the message that are readable by the UE in association with a first radio access technology and not by another UE in association with a second radio access technology.
Clause 12: The method of Clause 11, wherein the second radio access technology is an earlier generation-based release and the first radio access technology is a later generation-based release.
Clause 13: One or more apparatuses, comprising: one or more memories comprising executable instructions; and one or more processors configured to execute the executable instructions and cause the one or more apparatuses to perform a method in accordance with any one of Clauses 1-12.
Clause 14: One or more apparatuses configured for wireless communications, comprising: one or more memories; and one or more processors, coupled to the one or more memories, configured to cause the one or more apparatuses to perform a method in accordance with any one of Clauses 1-12.
Clause 15: One or more apparatuses configured for wireless communications, comprising: one or more memories; and one or more processors, coupled to the one or more memories, configured to perform a method in accordance with any one of Clauses 1-12.
Clause 16: One or more apparatuses, comprising means for performing a method in accordance with any one of Clauses 1-12.
Clause 17: One or more non-transitory computer-readable media comprising executable instructions that, when executed by one or more processors of one or more apparatuses, cause the one or more apparatuses to perform a method in accordance with any one of Clauses 1-12.
Clause 18: One or more computer program products embodied on one or more computer-readable storage media comprising code for performing a method in accordance with any one of Clauses 1-12.
Clause 19: A user equipment (UE), comprising: a processing system that includes processor circuitry and memory circuitry that stores code and is coupled with the processor circuitry, the processing system configured to cause the UE to perform a method in accordance with any one of Clauses 1-12.
Clause 20: One or more apparatuses configured for wireless communications, comprising: a processing system that includes one or more processors and one or more memories coupled with the one or more processors, the processing system configured to cause the one or more apparatuses to perform a method in accordance with any one of Clauses 1-12.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining”may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. A user equipment (UE), comprising a processing system that includes one or more processors and one or more memories coupled with the one or more processors, the processing system configured to cause the UE to:
receive, from a network entity, a message comprising physical random access channel (PRACH) adaptation information, wherein the PRACH adaptation information is included in one of:
one or more reserved bits of the message, or
a paging early indication (PEI) of the message; and
perform a random access channel (RACH) procedure based on the PRACH adaptation information.

2. The UE of claim 1, wherein the PRACH adaptation information comprises an indication of a change in an activation state for PRACH adaptation.

3. The UE of claim 2, wherein the indication of the change in the activation state is associated with an indication included in a system information message.

4. The UE of claim 3, wherein the processing system is configured to cause the UE to:
receive the system information message in response to receiving the message; and
perform the RACH procedure, based on the system information message, in accordance with the change in the activation state for the PRACH adaptation.

5. The UE of claim 1, wherein the message comprises a paging downlink control information (DCI) message.

6. The UE of claim 5, wherein the paging DCI message comprises one or more fields that indicate no change in system information associated with the network entity.

7. The UE of claim 5, wherein the paging DCI message indicates that system information associated with the network entity has changed only with regard to an activation state for PRACH adaptation.

8. The UE of claim 1, wherein the message comprises the PEI.

9. The UE of claim 8, wherein the PEI comprises one or more fields that indicate that there is no paging to monitor in a corresponding paging occasion.

10. The UE of claim 8, wherein the PRACH adaptation information comprises a PEI radio network temporary identifier (PEI-RNTI) associated with an indication of a change in an activation state for PRACH adaptation.

11. The UE of claim 1, wherein the one or more reserved bits comprise one or more bits of the message that are readable by the UE in association with a first radio access technology and not by another UE in association with a second radio access technology.

12. The UE of claim 11, wherein the second radio access technology is an earlier generation-based release and the first radio access technology is a later generation-based release.

13. A method for wireless communications by an apparatus comprising:
receiving, from a network entity, a message comprising physical random access channel (PRACH) adaptation information, wherein the PRACH adaptation information is included in one of:
one or more reserved bits of the message, or
a paging early indication (PEI) of the message; and
performing a random access channel (RACH) procedure based on the PRACH adaptation information.

14. The method of claim 13, wherein the PRACH adaptation information comprises an indication of a change in an activation state for PRACH adaptation.

15. The method of claim 14, wherein the indication of the change in the activation state is associated with an indication included in a system information message.

16. The method of claim 15, further comprising:
receiving the system information message in response to receiving the message; and
performing the RACH procedure, based on the system information message, in accordance with the change in the activation state for the PRACH adaptation.

17. The method of claim 13, wherein the message comprises a paging downlink control information (DCI) message.

18. The method of claim 17, wherein the paging DCI message comprises one or more fields that indicate no change in system information associated with the network entity.

19. The method of claim 17, wherein the paging DCI message indicates that system information associated with the network entity has changed only with regard to an activation state for PRACH adaptation.

20. An apparatus for wireless communications, comprising:
means for receiving, from a network entity, a message comprising physical random access channel (PRACH) adaptation information, wherein the PRACH adaptation information is included in one of:
one or more reserved bits of the message, or
a paging early indication (PEI) of the message; and
means for performing a random access channel (RACH) procedure based on the PRACH adaptation information.
